(19) United States
(12) Patent Application Publication
(10) Pub. No.: US 2005/0117486 A1
(43) Pub. Date: Jun. 2, 2005

(54) Optical pickup unit and optical disk unit

(75) Inventor: Sou Ishika, Yokohama-shi (JP)

Correspondence Address: PILLSBURY WINTHROP, LLP, P.O. BOX 10500, MCLEAN, VA, 22102, US

(73) Assignee: Kabushiki Kaisha Toshiba, Tokyo (JP)

(21) Appl. No.: 10/945,264

(22) Filed: Sep. 21, 2004

(30) Foreign Application Priority Data
Nov. 28, 2003 (JP) 2003-400796

(51) Int. Cl. G11B 5/55; G11B 7/00

(52) U.S. Cl. 369/53.26; 369/116

(57) ABSTRACT

An optical pickup unit has a light emitting device which emits laser light, and a monitor unit formed of a transparent resin, which integrally forms a photoreceptor device which receives the laser light and a circuit device connected to the photoreceptor device. A part of the transparent resin of the monitor unit is disposed in a part of an optical path of the laser light, the transparent resin causes part of the laser light to be reflected or refracted for supply to the photoreceptor device, the photoreceptor device outputs a detection signal corresponding to the part of the laser light, and upon receipt of the detection signal from the photoreceptor device, the circuit device performs a signal process and produces an output.

### CROSS-REFERENCE TO RELATED APPLICATIONS

This application is based upon and claims the benefit of priority from prior Japanese Patent Application No. 2003-400796, filed Nov. 28, 2003, the entire contents of which are incorporated herein by reference.

### BACKGROUND OF THE INVENTION

1. Field of the Invention

The invention relates to the configuration of a photoreceptor device which is provided in an optical pickup of an optical disk unit and which directly detects light quantity of laser light from a light emitting device. More specifically, the invention relates to an optical disk unit using a monitor unit integrally formed of a laser-light reflection/refraction mechanism, photoreceptor device, and circuit device by using a transparent resin.

2. Description of the Related Art

Generally, as a method of controlling the intensity of laser emanation light, an optical disk unit employs a method using an APC (auto power controller) circuit. The APC circuit detects laser emanation light, and inputs a front monitor signal which is proportional to a detection amount of the laser light. In this case, a front monitor to be built in an optical pickup should be provided separately from a photodetector which receives reflected light of the laser light from an optical disk. This makes it difficult to miniaturize the optical pickup. As techniques for compactly mounting the front monitor, related techniques as described below is known.

Jpn. Pat. Appln. KOKAI Publication No. 2002-352458 discloses an optical head which takes off part of laser light having just been emitted from a photodiode via an optical fiber and which controls a front monitor to detect the part of laser light. The front monitor in this case can be relatively compactly mounted.

However, the prior art disclosed in Jpn. Pat. Appln. KOKAI Publication has problems in that, for example, wiring of the optical fiber is intricate, as it requires high precision. In addition, the optical fiber lacks the strength against mechanical shocks, and can cause significant influence on the magnitude of a detection signal depending on the mounting state.

### BRIEF SUMMARY OF THE INVENTION

An embodiment according to the invention is an optical pickup unit comprises a light emitting device which emits laser light; and a monitor unit formed of a transparent resin, which integrally forms a photoreceptor device which receives the laser light and a circuit device connected to the photoreceptor device. A part of the transparent resin of the monitor unit is disposed in a part of an optical path of the laser light; the transparent resin causes part of the laser light to be reflected or refracted for supply to the photoreceptor device; the photoreceptor device outputs a detection signal corresponding to the part of the laser light; and upon receipt of the detection signal from the photoreceptor device, the circuit device performs a signal process and produces an output.

### BRIEF DESCRIPTION OF THE SEVERAL VIEWS OF THE DRAWING

FIG. 1 is a cross-sectional view showing an example of the configuration of a monitor unit in an optical pickup unit according to the present invention;

FIG. 2 is a block diagram showing an example of the configuration of an optical disk unit using the optical pickup unit according to the invention;

FIG. 3 is an explanatory view showing an example of the interior configuration of the optical pickup unit according to the invention;

FIG. 4 is an explanatory view showing an example of the configuration of an APC circuit of the optical disk unit according to the invention;

FIG. 5 is a solid diagram showing an example of the configuration of the monitor unit according to the invention; and

FIG. 6 is a cross-sectional view showing another example configuration of a monitor unit in the optical pickup unit according to the present invention.

### DETAILED DESCRIPTION OF THE INVENTION

Embodiments according to the present invention will be described below with reference to the drawings.

<Optical Disk Unit According to the Invention>

Examples of optical disk units according to the invention will be described hereunder with reference to the drawings.

(Configuration)

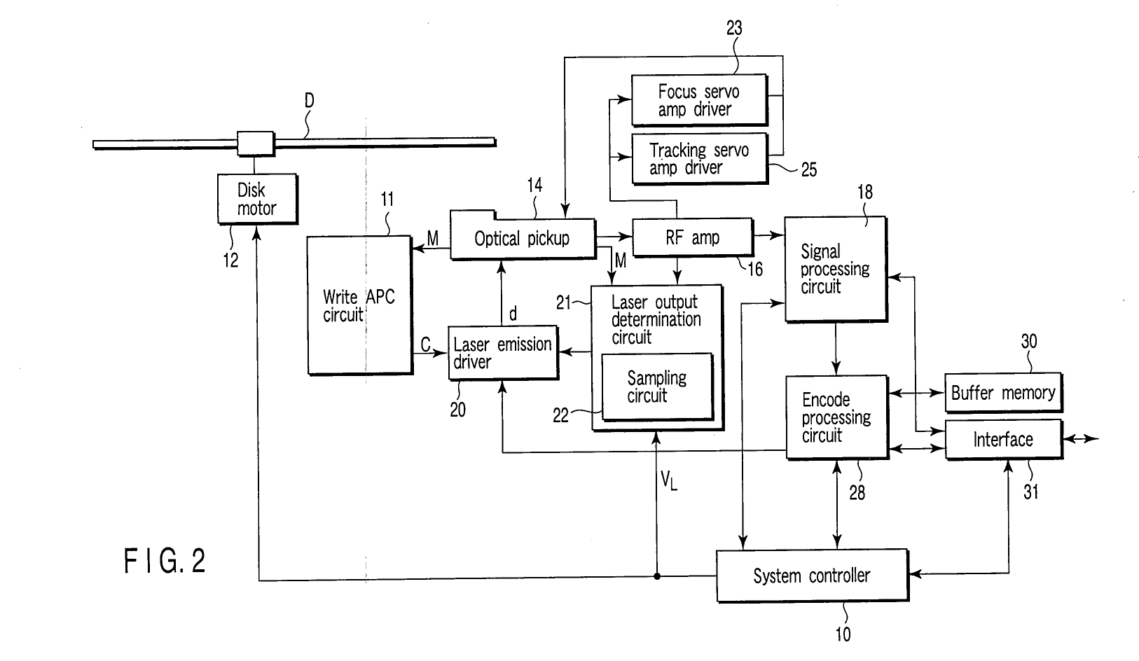

Referring to FIG. 2, the optical disk unit has an optical disk motor 12 which supports and drives an optical disk D to rotate at a predetermined speed rate; an optical pickup unit 14 which emits an optical beam to the optical disk D and detects reflected light; an RF amp (amplifier) 16 which is supplied with a detected signal and which generates a servo-control signal; a signal processing circuit 18 and a laser output determination circuit 21 which are each supplied with an RF signal. In addition, the optical disk unit has an interface 31 which exchanges data with the outside; and a buffer memory 30 which is connected to the interface 31 to temporarily store, for example, supplied data or playback data having been read by the optical pickup unit 14.

The optical disk unit further has an encode processing circuit 28 which is connected to the buffer memory 30 and the interface 31 to encode supplied data; and a laser emission driver 20 which is supplied with an output encoded by the encode processing circuit 28. The laser emission driver 20 produces a laser emission drive signal d under control of a control signal received from the laser output determination circuit 21 connected to a system controller 10 which manage the total system operation. Thereby, the laser light corresponding to the RF signal, which is supplied from the RF amplifier 16, is generated through the optical pickup unit 14. The system controller 10 is connected to the above-described individual portions to control operations thereof. As described below in detail, the system controller 10 includes a correction amount determination section. This determination section performs a detection process and a determination process for a correction process which is performed by a write APC circuit 11. The detection process detects an error amount corresponding to wringing and waveform abnormality or corruption, and the determination process determines a correction signal corresponding to the error amount.

The optical disk unit has a focus servo amp driver 23 and a tracking servo amp driver 25. The focus servo amp driver 23 operates to enable focus control of the optical pickup unit 14 upon receipt of the focus error signal, which is the servo-control signal, generated by the RF amp 16. The tracking servo amp driver 25 operates to enable tracking control of the optical pickup unit 14 upon receipt of the track error signal, which is the servo-control signal, received from the RF amp 16.

Additionally, with reference to FIG. 3, the optical pickup unit 14 of the optical disk unit according to the invention has an actuator 39 having an objective lens 42. In the actuator 39, a track-direction actuator drive coil 40 and a focus-direction actuator drive coil 41 are provided. In the present case, a tracking control signal C_{T} and focus control signal C_{F} are supplied, respectively, from the focus servo amp driver 23 and tracking servo amp driver 25 described above, whereby servo control is enabled.

The optical pickup unit 14 performs both emission and photoreception in accordance with operations of a beamsplitter 37 and the like. Laser light emitted from a photodiode 35 in correspondence to the drive signal d of the laser emission driver 20 passes through a lens 36 and the beamsplitter 37. Then, the laser light is focused by the objective lens 42 through, for example, a one-quarter (¼) waveplate 38, and is irradiated onto a predetermined region of the optical disk D. Further, reflected light from the optical disk D is expanded by the objective lens 42, is split by the beamsplitter 37 to the side of a focusing lens 34, and further, is supplied to a photodetector 32. The photodetector 32 supplies a detection signal S. The tracking error signal and the focus error signal are supplied to the tracking servo amp driver 25 and the focus servo amp driver 23, respectively. Further, the detection signal S for generating a replay signal is supplied to the signal processing circuit 18.

The optical disk unit according to the invention has a write APC (auto power controller) circuit 11 which receives a front monitor signal M from a front monitor 33 of the optical pickup unit 14 and which supplies to the laser emission driver 20 an appropriate control signal C corresponding to the front monitor signal M whereby to perform control of the laser emission driver 20. In particular, the write APC circuit 11 performs output control of laser light in the event of a write to the optical disk D.

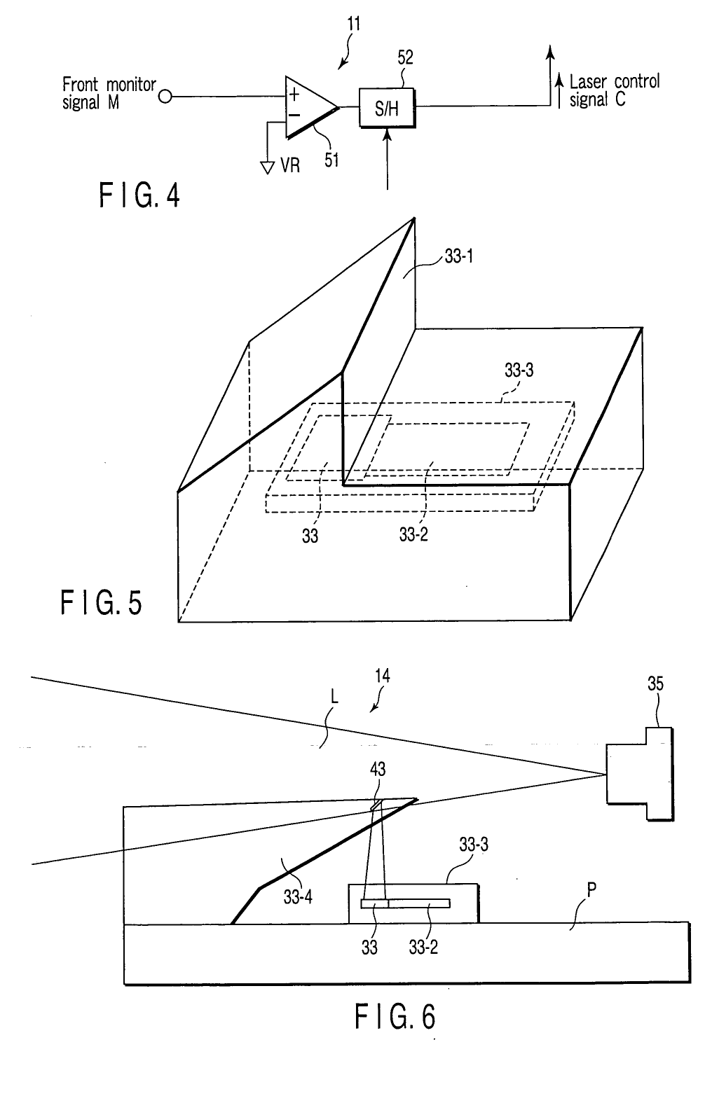

As shown in FIG. 4, the write APC circuit 11 has a gain amp 51 and a sampling hold circuit 52. The gain amp 51 receives the front monitor signal M from the front monitor 33 of the optical pickup unit 14 and a voltage VR indicative of a control target value. The sampling hold circuit 52 is supplied with an output of the gain amp 51.

(Basic Operation)

In the optical disk unit having the configuration described above, an optical-disk replay process is performed as follows. Under the control of the system controller 10, the optical disk D rotated by the optical disk motor 12 at a predetermined speed rate generates laser light corresponding to the laser emission driver 20 set by the laser output determination circuit 21. Reflected light of the laser light is detected by the optical pickup unit 14, and a detection signal corresponding to the reflected light is output. The detection signal is supplied to the RF amp 16, and the RF signal output therefrom is supplied to the signal processing circuit 18 and the laser output determination circuit 21. Concurrently, a focus error signal and tracking error signal generated in the RF amp 16 are supplied to the focus servo amp driver 23 and tracking servo amp driver 25, respectively. In the signal processing circuit 18, the RF signal is decoded, and a decoded signal is temporarily stored into the buffer memory 30 or is output to the outside through the interface 31. In addition, the system controller 10 generates a control signal for controlling the rotation of the optical disk motor 12, thereby controlling the rotation of the optical disk motor 12.

Further, in the optical disk unit thus configured, an optical-disk record process is performed as follows. Under the control of the system controller 10, data supplied through, for example, the interface 31, is temporarily stored into the buffer memory 30 and is thereafter supplied to the encode processing circuit 28. In this manner, the data is encoded and output. Corresponding to the encoded output and the output of the laser output determination circuit 21, a driver output of the laser emission driver 20 is supplied to the optical pickup unit 14. In the optical pickup unit 14, laser light corresponding to the driver output of the laser emission driver 20 is emitted from the mounted photodiode 35 and is irradiated onto a storage area of the optical disk D rotated by the optical disk motor 12 at a predetermined speed rate, whereby the record process is performed.

<Monitor Unit Included in the Optical Pickup Unit According to the Invention>

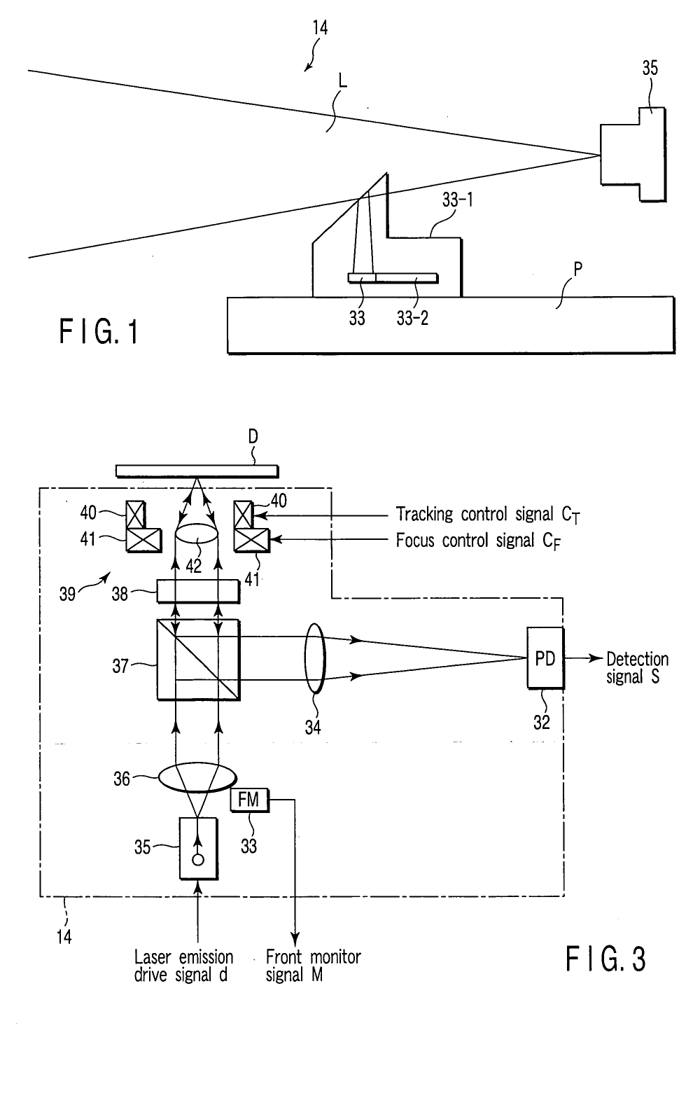

A monitor unit according to the invention, which is included in the optical pickup unit 14 according to the invention, will be described in detail below with reference to the drawings. Referring to FIG. 1, a monitor unit 33-1 according to the invention has a photoreceptor device 33 formed of a photodiode or the like; and a circuit device 33-2 including, for example, an amp circuit which amplifies a low output signal of the photoreceptor device 33 and which supplies the signal to, for example, a backstage control circuit. The photoreceptor device 33 and the circuit device 33-2 are integrally formed by using a transparent resin such as a polycarbonate.

The configuration of the transparent resin in this case is disposed so as to acquire part of laser light of the photodiode 35 which is a light emitting device for emitting laser light L. Specifically, as shown in FIG. 1, the configuration is formed and disposed to have a part of the transparent resin which intersects with a part of an optical path L. Thereby, influence on the laser light L can be minimized, the area of the place for mounting the monitor unit 33-1 can be minimized, and the optical pickup unit 14 can be miniaturized overall. In this case, a reflecting mirror may be provided to guide the laser light to the photoreceptor device. In addition, it is preferable that the transparent resin in a region where reflection or refraction takes place be formed independently of an other transparent resins, and be later formed by being adhered with the other transparent resin.

In the configuration in which the photoreceptor device 33 and the circuit device 33-2 are integrally formed by using the transparent resin, the configuration has high mechanical strength and enables minimizing the load to be imposed on an assembly worker for the monitor unit 33-1.

For example, the monitor unit 33-1 is disposed and adhered to a flexible substrate P on which the laser emission driver 20 shown in FIG. 2 and the like are mounted. Thereby, mounting of the monitor unit 33-1 can be facilitated, and mechanical strength can be imparted. In addition, the electrical wiring enables amplified signals from the monitor unit 33-1 to be easily supplied to the flexible substrate P.

As shown in FIG. 5 in detail, the monitor unit 33-1 is preferably formed such that the photoreceptor device 33 and the circuit device 33-2 are provided on a single semiconductor chip 33-3, such as a silicon chip. This enables stabilizing electrical performance and reducing the number of assembly steps.

An optical pickup unit 14 shown in FIG. 6 is configured such that the monitor unit 33-3 is mounted on the flexible substrate P, and a transparent resin 33-4 serving as a housing member of the optical pickup unit 14 is mounted in an optimal position with respect to a monitor unit 33-3 on the flexible substrate P. The transparent resin 33-4 serving as the housing member is mounted to intersect with a part of the optical path L of the laser light to thereby guide the part of the laser light to the photoreceptor device 33. In this case, a reflecting mirror 43 may be provided. With the monitor unit 33-3 thus mounted, the configuration is formed such that the reflecting mirror 43 serving as the housing member of the optical pickup unit 14 is used, and space reduction for the monitor unit 33-3 is implemented. Thereby, the monitor unit, optical pickup unit, and optical disk unit using them can be provided that are entirely compact, excellent in mechanical strength, and excellent in stability, and assembly is facilitated.

As described above, in the optical pickup unit according to the invention, the monitor unit including the front monitor for detecting the light quantity of the laser light is formed in the manner that the photoreceptor device and the circuit device connected thereto are integrally formed by using the transparent resin. In addition, the part of the transparent resin of the monitor unit is disposed in the part of the optical path of the laser light, whereby the part of the laser light is reflected or refracted and thereby introduced into the photoreceptor device. Thereby, since the monitor unit can be disposed near the optical path of the laser light, the optical pickup unit can be miniaturized.

Since both the photoreceptor device and circuit device are integrally formed with the transparent resin, the monitor unit is excellent in mechanical strength. In addition, since the work of disposing the monitor unit is also performed such that, for example, the monitor unit is adhered to a predetermined position on the flexible substrate, the work can be easily and securely performed. Consequently, the optical pickup unit excellent in operational stability can be provided. Accordingly, the optical disk device is provided that is capable of stably performing light quantity control of laser light and performing a stabilized playback/record process.

According to the various embodiments described above, those concerned in the art will be able to implement the invention, and various other modified examples will easily occur to those skilled in the art. Further, it will be possible even for those not having sufficient inventive knowledge and skills to adapt the invention by way of various other embodiments, and the invention may be applied to various embodiments even without having inventive skills. Accordingly, the invention is not limited to the above-described embodiments as it covers a broad range of applications as long as they do not contradict the principles and novel features disclosed herein. For example, while the above-described embodiments are each provided with the front monitor unit for the DVD-dedicated light, the monitor may be disposed such that after DVD-dedicated light (wavelength: close to 650 nm) and CD-dedicated light (wavelength: close to 780 nm) have been synthesized using a DP, and part of the light in contact with an external side of the aperture of the objective lens is incident on a PD.

1. An optical pickup unit comprising:
a light emitting device which emits laser light; and
a monitor unit formed of a transparent resin, which integrally forms a photoreceptor device which receives the laser light and a circuit device connected to the photoreceptor device, wherein
a part of the transparent resin of the monitor unit is disposed in a part of an optical path of the laser light,
the transparent resin causes part of the laser light to be reflected or refracted for supply to the photoreceptor device,
the photoreceptor device outputs a detection signal corresponding to the part of the laser light, and
the circuit device performs a signal process and produces an output upon receipt of the detection signal from the photoreceptor device.

2. An optical pickup unit according to claim 1, wherein the photoreceptor device and circuit device of the monitor unit are formed as an integral semiconductor device.

3. An optical pickup unit according to claim 1, wherein the monitor unit has a reflecting mirror which guides the part of the laser light to the photoreceptor device.

4. An optical pickup unit according to claim 1, wherein a main body formed by using the transparent resin is formed by adhering a transparent resin including a portion which performs reflection or refraction and an other transparent resin.

5. An optical pickup unit according to claim 1, wherein the monitor unit is fixed to a flexible substrate by being adhered thereto.

6. An optical pickup unit according to claim 1, wherein the flexible substrate includes a driver section which supplies a driving current to the light emitting device.

7. An optical pickup unit according to claim 1, wherein the main body of the monitor unit is a part of a housing member of the optical pickup unit.

8. An optical pickup unit according to claim 1, further comprising at least:
a beamsplitter through which the laser light passes;
a objective lens which focuses the passed laser light to be irradiated onto an optical disk; and
a photodetector for reflected light from the optical disk, the reflected light being supplied through the objective lens and the beamsplitter.

9. An optical pickup unit comprising:
a light emitting device which emits laser light;
a transparent resin member formed of a transparent resin as a part of a housing member of the optical pickup unit and disposed in a part of an optical path of the laser light, wherein the transparent resin causes a part of the laser light to be reflected or refracted for irradiation; and
a monitor unit formed of a transparent resin, which integrally forms a photoreceptor device and a circuit device connected to the photoreceptor device, wherein
the photoreceptor device outputs a detection signal upon receipt of the laser light from the transparent resin member, and
the circuit device performs a signal process and produces an output upon receipt of the detection signal from the photoreceptor device.

10. An optical pickup unit according to claim 9, wherein the transparent resin member has a reflecting mirror which guides the part of the laser light to the photoreceptor device.

11. An optical disk unit having an optical pickup unit, comprising:
a light emitting device which is included in the optical pickup unit and which emits laser light to an optical disk; and
a monitor unit which is included in the optical pickup unit and which is formed of a transparent resin which integrally forms a photoreceptor device which receives the laser light and a circuit device connected to the photoreceptor device, wherein
a part of the transparent resin of the monitor unit is disposed in a part of an optical path of the laser light,
the transparent resin causes part of the laser light to be reflected or refracted for supply to the photoreceptor device,
the photoreceptor device outputs a detection signal corresponding to the part of the laser light, and
the circuit device performs a signal process and produces an output upon receipt of the detection signal from the photoreceptor device;
an emission driver section which supplies to the light emitting device a driving current controlled in accordance with the detection signal which has been received from the monitor unit and which is subjected to the signal process;
a photodetector which is included in the optical pickup unit and which detects reflected light of the laser light from the optical disk, the laser light having been irradiated from the light emitting device; and
a playback section which demodulates the detection signal received from the photodetector and performs playback thereof.

12. An optical disk unit according to claim 11, wherein the photoreceptor device and circuit device of the monitor unit are formed as an integral semiconductor device.

13. An optical disk unit according to claim 11, wherein the monitor unit has a reflecting mirror which guides the part of the laser light to the photoreceptor device.

14. An optical disk unit according to claim 11, wherein a main body formed by using the transparent resin is formed by adhering a transparent resin including a portion which performs reflection or refraction and an other transparent resin.

15. An optical disk unit according to claim 11, wherein the monitor unit is fixed to a flexible substrate by being adhered thereto.

16. An optical disk unit according to claim 15, wherein the flexible substrate includes a driver section which supplies a driving current to the light emitting device.

17. An optical disk unit according to claim 11, wherein the main body of the monitor unit is a part of a housing member of the optical pickup unit.

18. An optical disk unit according to claim 11, wherein the optical pickup unit has at least:
a beamsplitter through which the laser light passes;
a objective lens which focuses the passed laser light to be irradiated onto an optical disk; and
a photodetector for reflected light from the optical disk, the reflected light being supplied through the objective lens and the beamsplitter.

19. An optical disk unit comprising:
a light emitting device which emits laser light;
a transparent resin member formed of a transparent resin as a part of a housing member of the optical pickup unit and disposed in a part of an optical path of the laser light, wherein the transparent resin causes a part of the laser light to be reflected or refracted for irradiation; and
a monitor unit formed of a transparent resin, which integrally forms a photoreceptor device and a circuit device connected to the photoreceptor device, wherein
the photoreceptor device outputs a detection signal upon receipt of the laser light from the transparent resin member, and
the circuit device performs a signal process and produces an output upon receipt of the detection signal from the photoreceptor device.

20. An optical disk unit according to claim 19, wherein the transparent resin member has a reflecting mirror which guides the part of the laser light to the photoreceptor device.
